(19) United States
(12) Patent Application Publication
(10) Pub. No.: US 2003/0010353 A1
(43) Pub. Date: Jan. 16, 2003

(54) Ultrasonic cleaning method for semiconductor manufacturing equipment

(76) Inventors: Naoshige Kawasaki, Tokyo (JP); Tomohiro Ishida, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/096,831

(22) Filed: Mar. 14, 2002

(30) Foreign Application Priority Data
Jul. 11, 2001 (JP) 2001-210634

(51) Int. Cl. B08B 3/12

(52) U.S. Cl. 134/1; 134/32

(57) ABSTRACT

An ultrasonic cleaning method for cleaning semiconductor manufacturing equipment with which a blast treated surface of a component of a sputtering equipment is cleaned, wherein de-aerated cleaning water in which the component is immersed has concentration of dissolved gasses of not more than 10 ppm, and ultrasonic power of the ultrasonic vibrator applying ultrasonic to the cleaning water is 50 W or more.

### FIELD OF THE INVENTION

The present invention relates to cleaning of semiconductor manufacturing equipment, especially to an ultrasonic cleaning method for components of sputtering equipment, and more specifically, to an ultrasonic cleaning method for cleaning the surface of the components which is treated by blast cleaning.

### BACKGROUND OF THE INVENTION

In production process of semiconductor elements, cleaning of semiconductor wafers is generally performed in order to increase a yield of good products. Similarly, components of semiconductor manufacturing equipment, such as components of sputtering equipment, are also cleaned to prevent appearance of dust. As a method of above cleaning, ultrasonic cleaning in which components are immersed into the pure water and ultrasonic is applied thereto is generally used. In the ultrasonic cleaning, foreign matters on the surface are removed by cavitation in the cleaning water which is generated by ultrasonic applied thereto.

Through recent researches, close relationship between concentration of dissolved oxygen (or dissolved gasses) in the cleaning water and amount of cavitation generated by ultrasonic is revealed. More specifically, strength of cavitation and impact caused by explosion thereof are greatly influenced by concentration of dissolved oxygen. That is, with lower concentration of dissolved gasses, generation of cavitation is promoted so that performance of removing foreign matters is enhanced. For example, according to Japanese Unexamined Patent Publication No. 77376/2000 wherein ultrasonic cleaning of semiconductor wafers is disclosed, performance of the ultrasonic cleaning is increased by decreasing the solubility of gasses in cleaning water.

In Japanese Unexamined Patent Publication No. 31942/1995, moreover, ultrasonic cleaning method to easily remove foreign matters, such as machining oil, soldering flux or machined debris, from a workpiece having a complicated shape is disclosed. In the method, the workpiece is located at airy position in closed washing bath, and then, the bath is vacuumed to prescribed atmospheric pressure so as to draw out the foreign matters from apertures on the complicated surface of the workpiece. Thereafter, the workpiece is immersed into de-aerated cleaning water and ultrasonic is applied thereto so that the foreign mattes on the workpiece are removed. In such a method, foreign matters are easily removed by ultrasonic cleaning. Moreover, excitation of cavitation can be controlled by the pressure in the washing bath to achieve washing in which strength of the workpiece is considered, thereby, foreign matters on the surface are removed without damaging the workpiece.

In production process of semiconductor elements, as described above, ultrasonic cleaning for semiconductor wafers with de-aerated water and ultrasonic cleaning for components of semiconductor manufacturing equipment are performed to remove/prevent foreign matters on the wafers so that a yield of good semiconductor elements is increased.

Meanwhile, in a semiconductor element having a multi-layered wiring structure, e.g. a system LSI and DRAM, a plug of tungsten (W) is buried to make an interlayer connection between wirings. The tungsten plug is preferably surrounded by barrier metal such as TiN, therefore, a process for forming a barrier metal film of TiN is carried out using a sputtering equipment and preceding to the formation of the tungsten plug.

In the above sputtering process for forming a TiN film, high voltage is applied between a target and a wafer so that the target material is knocked on to form the film on the wafer. At the same time, foreign matters and/or deposited film, which may be clinging onto the target and/or shield of the sputtering equipment, may come off to stick onto the wafer so that the yield of good semiconductor elements is decreased.

Therefore, blast cleaning is performed for the side surface of the target as well as the surfaces of the shield in order to prevent the above exfoliation of the deposited film. However, it is recently revealed that blast abrasives used for the blast cleaning remains on the surface and drops off during the sputtering process. Therefore, removal of these remained blast abrasives is a problem of urgency and importance.

For removing the remained blast abrasives, the above described ultrasonic cleaning in which object, i.e. the target or the shield, is immersed into pure water and ultrasonic is applied thereto is typically used. However, the above ultrasonic cleaning could not remove the blast abrasives sufficiently so that there is no way to efficiently remove the remained abrasives. Moreover, ultrasonic cleaning utilizing de-aerated water has never been applied to the components of sputtering equipment such as the target and/or shield, therefore, effectiveness and preferable washing conditions thereof in application to the blast cleaned objects are not investigated.

### SUMMARY OF THE INVENTION

The present invention is made to solve the above problems and an object thereof is to provide a cleaning method in which remained blast abrasives are effectively removed from the blast treated surface of the component of the sputtering equipment so as to increase a yield of good semiconductor elements.

To achieve the above and other objects, an ultrasonic cleaning method for cleaning semiconductor manufacturing equipment according to the present invention is for cleaning a blast treated surface of a component of a sputtering equipment, and wherein de-aerated cleaning water in which the component is immersed has concentration of dissolved gasses of not more than 10 ppm, and ultrasonic power of the ultrasonic vibrator applying ultrasonic to the cleaning water is 50 W or more.

According to the present invention, it is preferable that the de-aerated cleaning water has been overflowing during the ultrasonic cleaning.

According to the present invention, it is preferable that the component to be cleaned has been swung during the ultrasonic cleaning.

According to the present invention, it is preferable that frequency modulation is applied to the ultrasonic during the ultrasonic cleaning.

According to the present invention, moreover, it is preferable that an etching process is performed immersing the component into etchant before the ultrasonic cleaning.

According to the present invention, it is preferable that ultrasonic is applied to the etchant during the etching process.

According to the present invention, it is preferable that the etchant has been overflowing during the etching process.

According to the present invention, it is preferable that the component to be cleaned has been swung during the etching process.

According to the present invention, it is preferable that frequency modulation is applied to the ultrasonic during the etching process.

According to the present invention, furthermore, it is preferable that a pre-process in which gas is generated at the surface of the component immersed into processing agent is performed before the ultrasonic cleaning.

According to the present invention, it is preferable that ultrasonic is applied to the processing agent during the pre-process.

According to the present invention, it is preferable that the processing agent has been overflowing during the pre-process.

According to the present invention, it is preferable that the component to be cleaned has been swung during the pre-process.

According to the present invention, it is preferable that frequency modulation is applied to the ultrasonic during the pre-process.

According to the present invention, furthermore, it is preferable that the component to be cleaned is subjected to a shower of etchant before the ultrasonic cleaning.

According to the present invention, it is preferable that the component to be cleaned has been swung in the shower of etchant.

As described above, an ultrasonic cleaning method for cleaning semiconductor manufacturing equipment according to the present invention is for cleaning a blast treated surface of a component of a sputtering equipment, and wherein de-aerated cleaning water in which the component is immersed has concentration of dissolved gasses of not more than 10 ppm, and ultrasonic power of the ultrasonic vibrator applying ultrasonic to the cleaning water is 50 W or more. Accordingly, generation of cavitation in the cleaning water is promoted so that blast abrasives stricken into the surface of the component, which could not be removed by the conventional method using water without de-aeration, can be removed, thereby, foreign matters on the semiconductor element is decreased so that production yield thereof is increased.

Further, in the ultrasonic cleaning method for semiconductor manufacturing equipment of the present invention, since ultrasonic cleaning is carried out while overflowing the de-aerated water from the bath, the de-aerated water at the surface of the component is always refleshed so that remained blast abrasives on the component can be removed without decreasing cavitation generated by the ultrasonic.

Further, in the ultrasonic cleaning method for semiconductor manufacturing equipment of the present invention, since the ultrasonic cleaning is carried out while the component is swung within the washing bath, the effect of ultrasonic wave is enhanced and remained blast abrasives stricken into the surface of the component can be removed.

Further, in the ultrasonic cleaning method for semiconductor manufacturing equipment of the present invention, since the ultrasonic cleaning is carried out while applying ultrasonic with frequency modulation to de-aerated water, effect of ultrasonic wave is enhanced and remained blast abrasives stricken into the surface of the component can be removed.

Further, in the ultrasonic cleaning method for semiconductor manufacturing equipment of the present invention, since a blast treated surface of a component of a semiconductor manufacturing equipment is etched by etchant before the ultrasonic cleaning with de-aerated water, remained blast abrasives stricken into the surface of the component can be removed effectively. As a result, foreign matters on semiconductor element can be reduced substantially and production yield thereof is further increased.

Further, in the ultrasonic cleaning method for semiconductor manufacturing equipment of the present invention, since ultrasonic is applied to the etchant during the pre-process of etching, the etchant effectively reacts to the component, resulting in enlargement of the interface gap between stricken blast abrasives and the component so that remained blast abrasives is easily removed.

Further, in the ultrasonic cleaning method for semiconductor manufacturing equipment of the present invention, since etchant is overflowed during the pre-process of etching, etchant at the surface of the component is always refleshed so that degradation of the etchant is prevented, resulting in enlargement of the interface gap between stricken blast abrasives and the component, thereby remained blast abrasives is easily removed.

Further, in the ultrasonic cleaning method for semiconductor manufacturing equipment of the present invention, since the component to be washed is swung within the bath during the pre-process of etching, the etchant at the surface of the component is always refleshed so that degradation of the etchant is prevented, resulting in enlargement of the interface gap between stricken blast abrasives and the component, thereby remained blast abrasives is easily removed.

Further, in the ultrasonic cleaning method for semiconductor manufacturing equipment of the present invention, since ultrasonic with frequency modulation is applied to the etchant during the pre-process etching, the etchant at the surface of the component is always refleshed so that degradation of the etchant is prevented, resulting in enlargement of the interface gap between stricken blast abrasives and the component, thereby remained blast abrasives is easily removed.

Further, in the ultrasonic cleaning method for semiconductor manufacturing equipment of the present invention, since a blast treated surface of a component of a semiconductor manufacturing equipment is subjected to a pre-process in which gas is generated at the surface of the component immersed into an agent before the ultrasonic cleaning using de-aerated water, stricken blast abrasives on the surface of the component is eased by effect of the generated gas so that removal thereof becomes easier. As a result, foreign matters on the semiconductor element can be substantially reduced and production yield thereof can be further improved.

Further, in the ultrasonic cleaning method for semiconductor manufacturing equipment of the present invention, since ultrasonic is applied to the agent during the above pre-process, the agent well reacts to the component to ease remained blast abrasives stricken into the surface of the component so that the remained blast abrasives can be effectively removed.

Further, in the ultrasonic cleaning method for semiconductor manufacturing equipment of the present invention, since the agent is overflowed during the above pre-process, the agent at the surface of the component is always refreshed, resulting in prevention from decrease in gas generation from the surface of the component, so that the remained blast abrasives can be effectively removed.

Further, in the ultrasonic cleaning method for semiconductor manufacturing equipment of the present invention, since the component is swung within the agent during the pre-processing, the agent at the surface of the component is always refreshed, resulting in prevention from decrease in gas generation from the surface of the component, so that remained blast abrasives can be effectively removed.

Further, in the ultrasonic cleaning method for semiconductor manufacturing equipment of the present invention, since ultrasonic with frequency modulation is applied to the agent during the pre-processing, the agent at the surface of the component is always refreshed, resulting in prevention from decrease in gas generation from the surface of the component, so that remained blast abrasives can be effectively removed.

Further, in the ultrasonic cleaning method for semiconductor manufacturing equipment of the present invention, since a blast treated surface of a component of a semiconductor manufacturing equipment is showered with etchant before the ultrasonic cleaning using de-aerated water, stricken blast abrasives is easily removed from the surface of the component. Therefore, foreign matters on the semiconductor element is greatly reduced so that production yield thereof is further increased.

Further, in the ultrasonic cleaning method for semiconductor manufacturing equipment of the present invention, since the component is swung in the shower of etchant, the etchant at the surface of the component is always refreshed so that degradation of the etchant is prevented, resulting in enlargement of the interface gap between stricken blast abrasives and the component, thereby remained blast abrasives is easily removed.

These and other objects, advantages and features of the present invention will become more apparent from the following description and the accompanying drawings.

### BRIEF DESCRIPTION OF THE DRAWINGS

FIG. 1 shows an ultrasonic cleaning apparatus for Embodiment 1 of the present invention;

FIG. 2 shows a quantity of dust collected by ultrasonic cleaning method according to Embodiment 1 of the present invention in comparison with the conventional method;

FIG. 3 shows relationship between ultrasonic power and quantity of collected dust for the ultrasonic cleaning method of the present invention;

FIG. 4 shows relationship between concentration of dissolved oxygen in the cleaning water and quantity of collected dust for the ultrasonic cleaning method of the present invention;

FIG. 5 shows production yield of system LSI in the case where sputtering equipment whose components are cleaned by the ultrasonic cleaning method according to Embodiment 1 of the present invention is used;

FIG. 6 shows washing apparatuses for Embodiment 2 of the present invention;

FIG. 7 shows a quantity of dust collected by ultrasonic cleaning method according to Embodiment 2 in comparison with the ultrasonic cleaning method according to Embodiment 1 of the present invention;

FIG. 8 shows washing apparatuses for Embodiment 3 of the present invention;

FIG. 9 shows washing apparatuses for Embodiment 6 of the present invention;

FIG. 10 shows washing apparatuses for Embodiment 7 of the present invention; and

FIG. 11 shows washing apparatuses for Embodiment 10 of the present invention.

### DETAILED DESCRIPTION

### Embodiment 1

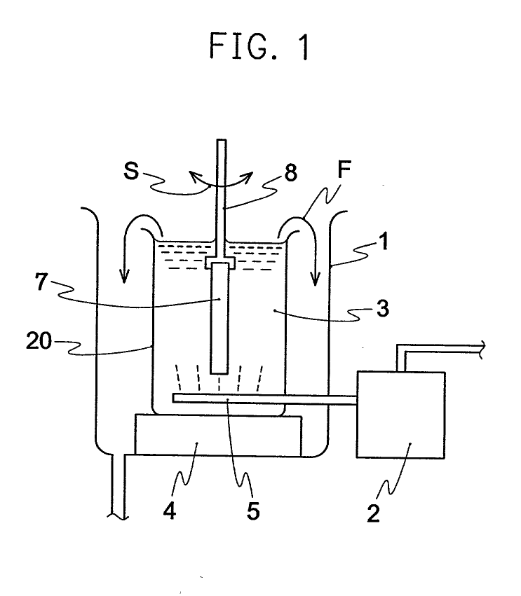

Embodiment 1 of the present invention is described with referring to FIG. 1. FIG. 1 shows an ultrasonic cleaning apparatus for Embodiment 1 of the present invention. In the figure, numeral 20 denotes an ultrasonic cleaning bath, numeral 2 denotes an apparatus for producing the de-aerated water, numeral 3 denotes the de-aerated water and numeral 7 denotes an object to be washed, respectively. As shown in FIG. 1, the ultrasonic cleaning bath 20 is filled with the de-aerated water 3 produced by the apparatus 2 and the object 7, e.g. a target or a shield which is used within a processing chamber of the sputtering equipment, is immersed into the de-aerated water 3. Of course, other components for other than that used in the processing chamber can be washed using the cleaning method according to the present invention. Meanwhile, the temperature of the de-aerated water 3 may be controlled not to deform and/or disqualify the object 7, and preferably ambient temperature around 25 degrees Celsius.

In FIG. 1, furthermore, numeral 4 denotes ultrasonic vibrator for generating ultrasonic wave which is necessary to remove foreign matters on the object to be washed. Numeral 5 denotes piping for supplying the de-aerated water into the washing bath 20 from the apparatus 2. The piping 5 is positioned below the object 7. By supplying the de-aerated water produced by the apparatus 2 via the piping 5 and overflowing the excess water from the washing bath 20 as shown with an arrow F in FIG. 1, the de-aerated water 3 around the object 7 is refreshed and the concentration of the dissolved gasses within the de-aerated water in the washing bath 20 is made constant not to increase. Moreover, numeral 8 denotes a device to swing the object 7 within the washing bath 20 (as shown with an arrow S in FIG. 1).

In the present embodiment, components of the spattering equipment such as a target and shield are washed utilizing the above described ultrasonic cleaning apparatus using de-aerated water.

In order to show advantages of the ultrasonic cleaning of the present embodiment, experiment is performed using a titanium (Ti) plate having a thickness of 3 mm and area of 50 mm² as for the object 7 to be washed. The material of the Ti plate is the same as that of a Ti target for a sputtering equipment, and a surface thereof is previously treated by blasting using blast abrasives of SiC #24. After performing ultrasonic cleaning for 10 minutes with ultrasonic power of 1.2 kW, the cleaning water is filtered to collect the dust, i.e. foreign matters, contained therein by using a filter paper having pores ranging from 0.2 to 1.0 μm in diameter. Thereafter, a quantity of the collected dust is estimated by measuring the weight thereof. During the ultrasonic cleaning in the present experiments, meanwhile, supply of the cleaning water is controlled not to overflow from the washing bath 20.

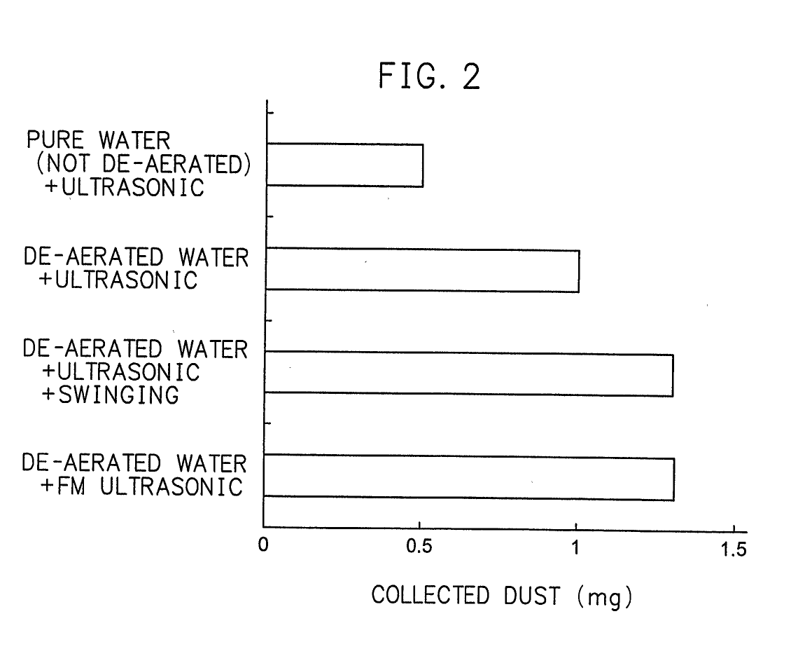

In FIG. 2, a quantity of the collected dust is shown for four ultrasonic cleaning methods, that is, (i) the conventional prior art method in which pure but not de-aerated water is used, (ii) the method according to the present embodiment in which de-aerated water is used, (iii) the method according to the present embodiment in which the object 7 is swung by the swinging device 8 during the ultrasonic cleaning using de-aerated water, and (iv) the method according to the present embodiment in which the frequency of the ultrasonic is varied, i.e. frequency modulated (FM), during the ultrasonic cleaning using de-aerated water.

As is clearly seen in FIG. 2, the ultrasonic cleaning of the present embodiment using de-aerated water shows washing performance approximately as twice as that of the conventional ultrasonic cleaning using pure but not de-aerated water. Furthermore, in the case where the object 7 is swung by the swinging device 8 during the ultrasonic cleaning using de-aerated water, washing performance thereof is further increased. Similarly, in the case where the frequency modulated (FM) ultrasonic is applied during the cleaning using de-aerated water, washing performance thereof is increased. Although not shown in FIG. 2, washing performance can be further enhanced when the swinging of object 7 and the frequency modulation of the ultrasonic are simultaneously carried out during the ultrasonic cleaning using de-aerated water.

As described above, according to the present embodiment in which blast treated surface of the components are cleaned by ultrasonic cleaning using de-aerated water, remained blast abrasives adhering to the surface can be removed, which can not be removed by the conventional ultrasonic cleaning with pure but not de-aerated water.

Meanwhile, although blast abrasives of SiC #24 are used for blasting the surface of the object to be washed in the above description, the same increase in washing performance is obtained even when the surface is treated by blast abrasives of other grain size and/or other material such as alumina.

Although the de-aerated water 3 is not overflowed from the washing bath 20 in the above experiments, further increase in washing performance can be obtained by overflowing the de-aerated water 3 from the washing bath 20. For example, ultrasonic cleaning with overflowing of the de-aerated water shows approximately same washing performance as of ultrasonic cleaning with de-aerated water in which the object is swung, or ultrasonic cleaning with de-aerated water in which frequency of ultrasonic is modulated. Moreover, in the case where overflowing of the de-aerated water is carried out together with the swinging of the object and/or frequency modulation of the ultrasonic, further enhanced washing performance can be obtained.

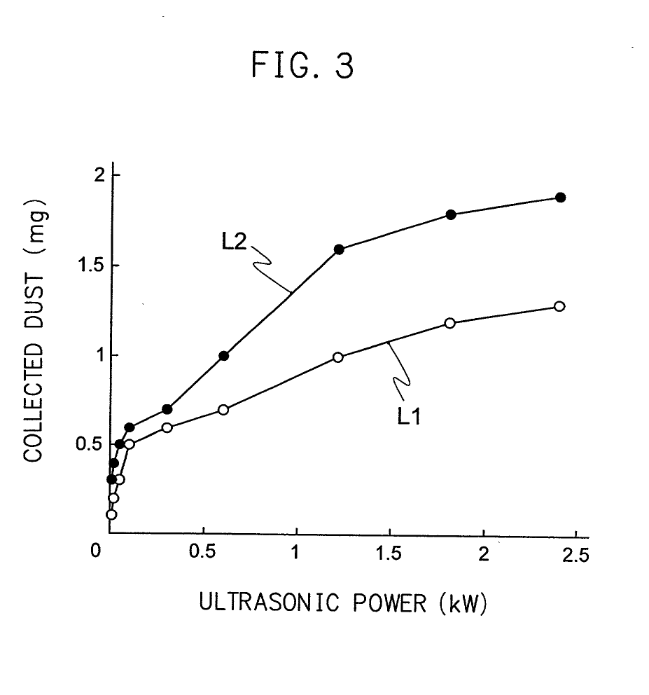

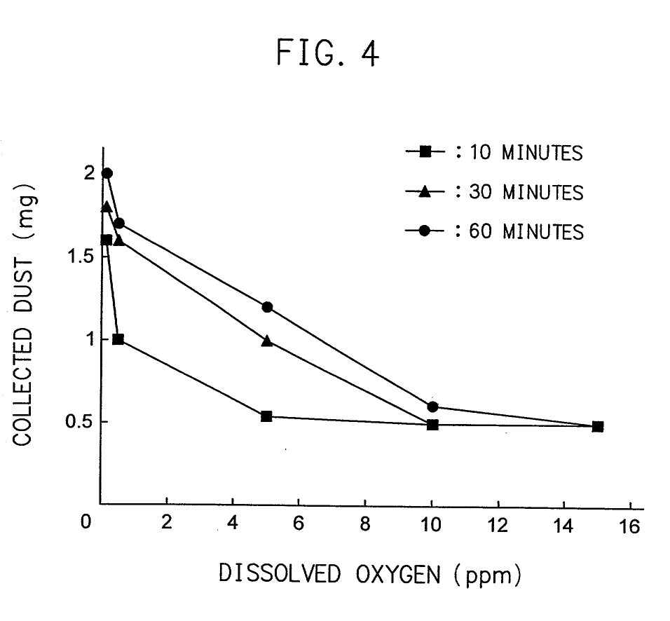

Next, washing conditions in ultrasonic cleaning with de-aerated water is described with referring to FIGS. 3 and 4. A curved line L1 connecting open circles in FIG. 3 shows correlation between ultrasonic power and quantity of collected dust for the ultrasonic cleaning of the present embodiment in which de-aerated water is used (swinging of the object and frequency modulation of the ultrasonic are not carried out here). As has already described above, Ti plate having an area of 50 mm², thickness of 3 mm, and a surface thereof treated by blast abrasives of SiC #24 is used for a sample object to be washed. For this sample object, ultrasonic cleaning of 10 minutes is performed with the various ultrasonic powers ranging from 0 to 2.4 kW. As shown with line L1 in FIG. 3, it is found that washing performance is increased with ultrasonic power. Further, although the washing performance is not remarkable with fewer ultrasonic power, the remarkable washing performance is shown with ultrasonic power of 0.05 kW or more. As already described with FIG. 2, quantity of collected dust is 0.5 mg for ultrasonic cleaning without de-aerated water. Based on this result and the graph in FIG. 3, it was found that ultrasonic power more than 0.05 kW provides the same or higher washing performance than that of the conventional ultrasonic cleaning without de-aerated water.

FIG. 4 shows correlation between concentration of dissolved oxygen in cleaning water and quantity of collected dust for the ultrasonic cleaning of the present embodiment using de-aerated water. As has already described above, Ti plate having an area of 50 mm², thickness of 3 mm, and a surface thereof treated by blast abrasives of SiC #24 is used for a sample object to be washed. For this sample object, ultrasonic cleaning of 10, 30 and 60 minutes are performed with the ultrasonic power of 1.2 kW. As shown in FIG. 4, quantity of collected dust decreases with increasing dissolved oxygen concentration. Moreover, it is found that quantity of collected dust increases with increasing washing time. Meanwhile, concentration of dissolved oxygen is approximately 15 ppm for the not de-aerated water. As shown in FIG. 4, with de-aerated water of 10 to 15 ppm dissolved oxygen, collected dust using de-aerated water is approximately as same as that using not de-aerated water. However, with de-aerated water of 10 ppm or less dissolved oxygen, collected dust using de-aerated water increases as compared with the conventional method using not de-aerated water.

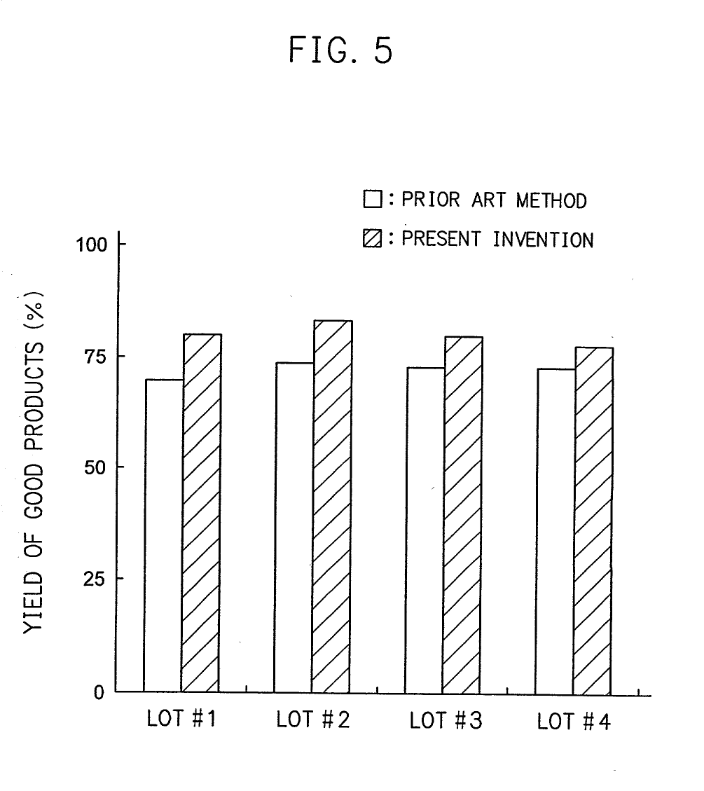

With sputtering equipment having a target and shield both cleaned by the ultrasonic cleaning of the present embodiment using de-aerated water, fabrication of a system LSI is carried out. FIG. 5 shows results of investigation of the production yield of system LSI produced by sputtering equipment where sputtering target and shield thereof are washed by ultrasonic cleaning of the present embodiment using de-aerated water. In FIG. 5, hatched bars show the yield of good products in the present embodiment wherein a target and shield are washed by ultrasonic cleaning using de-aerated water, while open bars show the yield of good product in the conventional washing method wherein a target and shield are washed by ultrasonic cleaning using pure but not de-aerated water. As shown in FIG. 5, production yield of a silicon wafer processed by sputtering equipment washed by the present embodiment is increased by 5 to 10 percents compared with that processed by sputtering equipment washed by the conventional washing method.

### Embodiment 2

We inventors have conducted investigation into relationship between remained blast abrasives on blasted components of semiconductor manufacturing equipment and foreign matters on a wafer treated by the equipment, and found that not only blast abrasives sticking onto the surface of the components but also blast abrasives stricken into the surface of the components are peeled off through sputtering process by temperature variation of the components, pressure variation of processing chamber and attacks of ionized atoms onto the side face of the target to appear as foreign matters on the wafer. That is, the remained blast abrasives stricken into the components has large effect on production yield of wafers.

For removing such stricken blast abrasives from the surface of components, ultrasonic cleaning with de-aerated water described in the above embodiment 1 is not sufficient. Therefore, ultrasonic cleaning method by which stricken abrasives on the components are efficiently removed is required to increase production yield. According to the present embodiment, such cleaning method is provided.

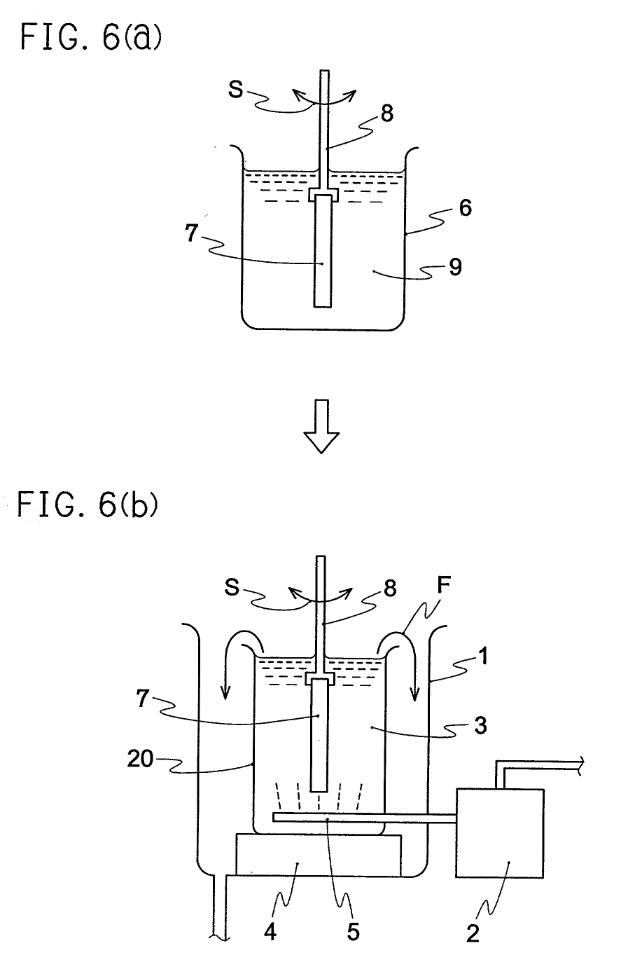

Hereinafter, the present embodiment is described with referring to figures. FIG. 6 shows washing apparatuses for Embodiment 2 of the present invention. FIG. 6(a) shows a pre-processing apparatus, while FIG. 6(b) shows an ultrasonic cleaning apparatus as same as that described in Embodiment 1. In the figure, numeral 6 denotes an etching bath in which an object 7 is etched, numeral 8 denotes a device to swing the object 7 within the etching bath 6 and numeral 9 denotes etchant filling the etching bath 6. As for the etchant, solution of hydrogen peroxide is preferable for the object made of aluminum and sulfuric acid is preferable for the object of stainless steel. Concentration of the etchant is not specified but should be moderate not to damage the object 7 and should be strong enough to slightly corrode the surface of the object 7 in order to penetrate into the interface between the object and the stricken abrasive to loose the stricken abrasive from the surface of the object. Temperature of the etchant is also not specified but should be in the range where etchant can lightly widen the interface gap between the object 7 and blast abrasives stricken thereinto without causing substantial corrosion of the object 7, therefore, ambient temperature around 25 degrees Celsius may be preferable.

In the present embodiment, an object 7 (i.e. a component of a sputtering equipment such as a target and shield) is etched within the etching bath 6 before subjected to the ultrasonic cleaning of the above Embodiment 1 using de-aerated water within the washing bath 20.

To show the advantage of the present embodiment, ultrasonic cleaning are performed for two cases. In the first case (i) which corresponds to Embodiment 2 of the present invention, a sample object 7 is subjected to the etching in the etching bath 6 for 10 minutes, and then subjected to the ultrasonic cleaning in the washing bath 20 filled with de-aerated water for 10 minutes. In the second case (ii) which corresponds to Embodiment 1 of the present invention, the ultrasonic cleaning in the washing bath 20 filled with de-aerated water is performed for 10 minutes without the above pre-process of etching.

For the above two cases, Ti plate having a thickness of 3 mm and area of 50 mm² is used as a sample object 7. The material of the Ti plate is the same as that of a Ti target used within a sputtering equipment, and a surface thereof is previously treated by blasting using blast abrasives of SiC #24. As for the etchant in the case (i), 10% sulfuric acid is used. In the above two cases, the sample object 7 is swung by the device 8 during the ultrasonic cleaning, while not swung during the etching.

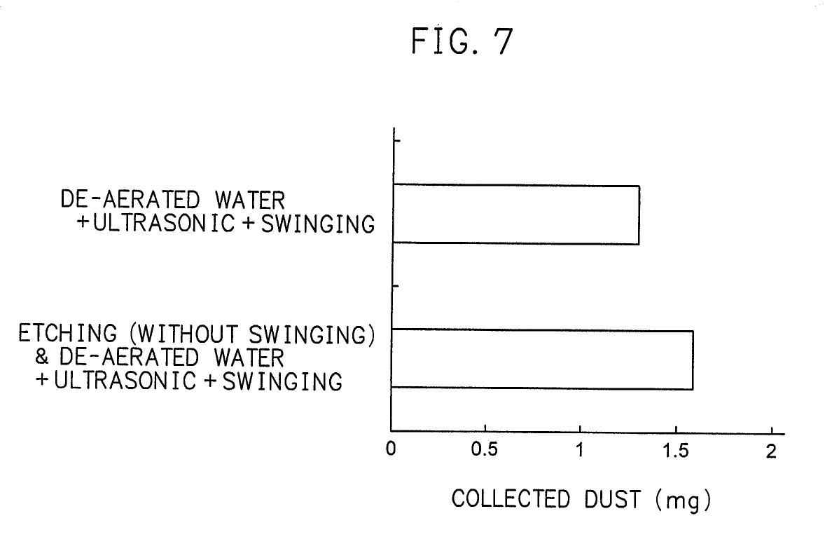

In FIG. 7, a quantity of collected dust is shown for each of the two cases. As is clearly shown in FIG. 7, by the ultrasonic cleaning of the present embodiment wherein both the pre-process of etching (without swinging of the object) and the ultrasonic cleaning with de-aerated water (with swinging of the object) are performed, much more blast abrasives (approximately 1.2 times) can be removed from the object compared with the ultrasonic cleaning of Embodiment 1 wherein the ultrasonic cleaning with de-aerated water (with swinging of the object) is solely performed.

With a curved line L2 connecting solid circles in FIG. 3, correlation between ultrasonic power and quantity of collected dust is shown for the ultrasonic cleaning of Embodiment 2 of the present invention. In FIG. 3, ultrasonic power ranges from 0 to 2.4 kW. As shown in FIG. 3, washing performance for removing blast abrasives is increased with increasing ultrasonic power, similarly to Embodiment 1 indicated with line L1 connecting open circles. Further, it can be seen that the washing performance of Embodiment 2 wherein the etching (without swinging) and the ultrasonic cleaning with de-aerated water (with swinging) are performed is approximately one and a half times as high as that of Embodiment 1 wherein only the ultrasonic cleaning with de-aerated water (without swinging) is performed.

Meanwhile, although the object 7 is not swung during the pre-process of etching in the above description, it is apparent that the object 7 may be swung within etchant 9 during the etching process. In the case where the object 7 is swung within etchant 9 during the etching process, more blast abrasives can be removed from the surface of the object compared with the above described embodiment in which the object 7 is not swung during the etching process.

### Embodiment 3

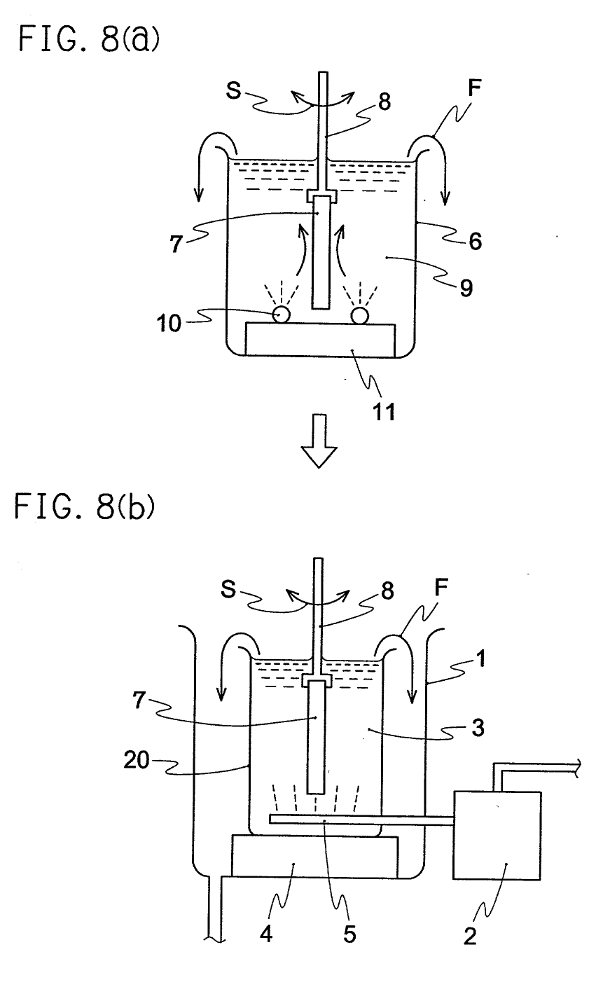

Hereinafter, the present embodiment is described with referring to FIG. 8. FIG. 8 shows washing apparatuses for Embodiment 3 of the present invention. FIG. 8(a) shows a pre-processing apparatus, while FIG. 8(b) shows an ultrasonic cleaning apparatus as same as that described in Embodiment 1. As shown in FIG. 8(a), piping 10 for supplying etchant 9 and an ultrasonic vibrator 11 for applying ultrasonic to the etchant 9 are added to the pre-processing apparatus of Embodiment 2 shown in FIG. 6(a).

In the present embodiment, an object 7 (i.e. a component of a sputtering equipment such as a target and shield) is etched within the etching bath 6 while overflowing the etchant 9 from the bath 6 by supplying excess etchant via the piping 10, applying ultrasonic to the etchant 9 by ultrasonic vibrator 11 and swinging the object 7 by the device 8, and thereafter, subjected to the ultrasonic cleaning of the Embodiment 1 using de-aerated water within the washing bath 20.

To show advantages of the present embodiment, a sample object is prepared and cleaned. For the sample object, Ti plate having a thickness of 3 mm and area of 50 mm² is used. The material of the Ti plate is the same as that of a Ti target used within a sputtering equipment, and a surface thereof is previously treated by blasting using blast abrasives of SiC #24. As for the etchant of the pre-process etching, 10% sulfuric acid is used. Both the pre-process etching within the bath 6 and the ultrasonic cleaning within the bath 20 are performed for 10 minutes, respectively. Thereafter, the dust, i.e. foreign matters or blast abrasives, removed from the sample object is collected and measured by the method using a filter paper as described with Embodiment 1.

As a result, a quantity of the dust collected by the present embodiment is one and half times as large as that of Embodiment 1 wherein only the ultrasonic cleaning with de-aerated water (with swinging) is performed. Therefore, by applying ultrasonic to the etchant 9 in the etching bath 6, overflowing the etchant 9 from the bath 6 and swinging the object 7 within the bath 6, remained blast abrasives stricken into the surface of the object can be removed much more satisfactory.

Meanwhile, without swinging of the object, that is, by applying ultrasonic to the etchant and overflowing the etchant from the bath, more blast abrasives can be removed from the object compared with the cleaning method of Embodiment 1 or 2. Similarly, even in a case where application of ultrasonic or overflowing of the etchant is solely performed during the etching process, more blast abrasives can be removed compared with the cleaning method of Embodiment 1 or 2.

Further, without applying ultrasonic, but overflowing of the etchant and swinging of the object are performed during the etching process, more blast abrasives stricken into the surface of the object can be removed compared with the cleaning method of Embodiment 1 or 2. Furthermore, without overflowing the etchant, but application of ultrasonic thereto and swinging of the object therewithin are performed, more blast abrasives can be removed from the object compared with the cleaning method of Embodiment 1 or 2.

### Embodiment 4

By varying frequency of the ultrasonic applied to the etchant, that is, by applying frequency modulated (FM) ultrasonic from the ultrasonic vibrator 11 during the pre-process etching in the ultrasonic cleaning of Embodiment 3, washing performance thereof is further enhanced. By applying frequency modulated ultrasonic to the etchant, although the object is not swung during the pre-process etching, the same or higher washing performance can be obtained compared with the ultrasonic cleaning of Embodiment 3 in which the object is swung during the pre-process etching.

### Embodiment 5

In the case where the cleaning method of Embodiment 3, that is, either or both of the etchant overflowing and the object swinging is combined with the application of frequency modulated ultrasonic of Embodiment 4 during the pre-process of etching, the performance for removing the remained blast abrasives from the object is further enhanced.

### Embodiment 6

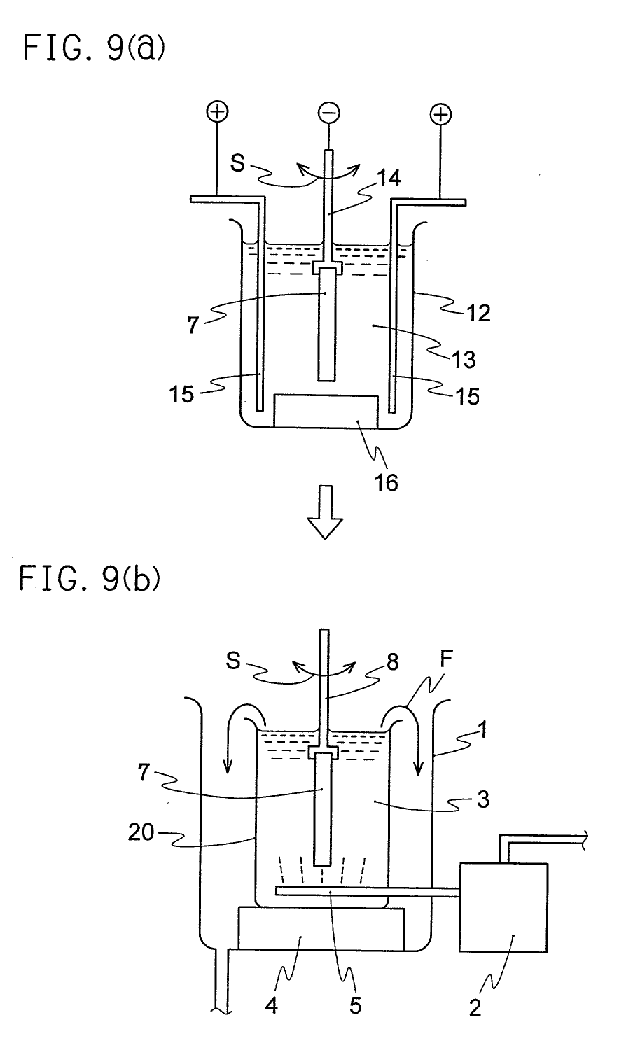

Hereinafter, the present embodiment is described with referring to FIG. 9. FIG. 9 shows washing apparatuses for Embodiment 6 of the present invention. FIG. 9(a) shows a pre-processing apparatus, while FIG. 9(b) shows an ultrasonic cleaning apparatus as same as that described in Embodiment 1. In the figure, numeral 12 denotes an electrolysis bath in which an object 7 to be cleaned is immersed, and numeral 13 denotes an electrolytic degreasing agent filling the bath 12. For the electrolytic degreasing agent 13, various agents prepared for steel articles may be applicable and commercially available. In the figure, furthermore, numeral 14 denotes a device for holding, and as shown with an arrow S in FIG. 9(a), for swinging the object 7 within the bath 12. Moreover, via the device 14 and object 7, electric voltage, e.g. negative voltage, is applied to the electrolytic degreasing agent 13. To apply electric voltage, e.g. positive voltage, to the electrolytic degreasing agent 13, an electrode 15 is arranged within the bath 12. By applying electric voltage to the electrolytic degreasing agent 13, gas is generated at the surface of the object 7 through electrochemical reaction such as electrolysis so that the blast abrasives stricken into the surface are eased to be removed. As show in FIG. 9(a), further, an ultrasonic vibrator 16 for applying ultrasonic to the electrolytic degreasing agent 13 is arranged within the bath 12.

In the present embodiment, an object 7 (i.e. a component of a sputtering equipment such as a target and shield) is subjected to electrolytic degreasing within the electrolysis bath 12 while applying ultrasonic to the electrolytic degreasing agent 13 by ultrasonic vibrator 16 and swinging the object 7 by the device 14, and thereafter, subjected to the ultrasonic cleaning of the Embodiment 1 using de-aerated water within the washing bath 20.

To show advantages of the present embodiment, a sample object is prepared and cleaned. For the sample object, Ti plate having a thickness of 3 mm and area of 50 mm² is used. The material of the Ti plate is the same as that of a Ti target used within a sputtering equipment, and a surface thereof is previously treated by blasting using blast abrasives of SiC #24. As for the electrolytic degreasing agent, a solution wherein mixture of sodium hydroxide 75%, sodium tri-phosphate 10%, sodium carbonate 14% and surfactant 1% is diluted to concentration of 80 g/L is used. Both of the pre-process electrolysis within the bath 12 and the ultrasonic cleaning within the bath 20 are performed for 10 minutes, respectively. Thereafter, the dust, i.e. foreign matters or blast abrasives, removed from the sample object is collected and measured by the method using a filter paper as described with Embodiment 1.

As a result, a quantity of the dust collected by the present embodiment is approximately 1.2 times as large as that of Embodiment 1 wherein only the ultrasonic cleaning with de-aerated water (with swinging) is performed. Therefore, by performing the pre-processing of electrolytic degreasing within the electrolysis bath, remained blast abrasives can be efficiently removed from the object.

Moreover, even when swinging of the object and application of the ultrasonic are not performed during the electrolytic degreasing, more remained blast abrasives stricken into the surface of the object can be removed compared with the cleaning method of Embodiment 1. Similarly, only applying ultrasonic to the electrolytic degreasing agent without swinging the object 7 or only swinging the object 7 without applying ultrasonic, blast abrasives stricken into the object is more sufficiently removed compared with the cleaning method of Embodiment 1.

### Embodiment 7

By varying frequency of the ultrasonic applied to the electrolytic degreasing agent, that is, by applying frequency modulated (FM) ultrasonic from the ultrasonic vibrator 16 during the electrolysis degreasing in the cleaning method of Embodiment 6, washing performance thereof is enhanced. By applying frequency modulated ultrasonic to the electrolytic degreasing agent, although the object is not swung during the electrolysis degreasing, 1.2 times higher washing performance can be obtained compared with the ultrasonic cleaning of Embodiment 6 in which the object is swung during the pre-process etching.

### Embodiment 8

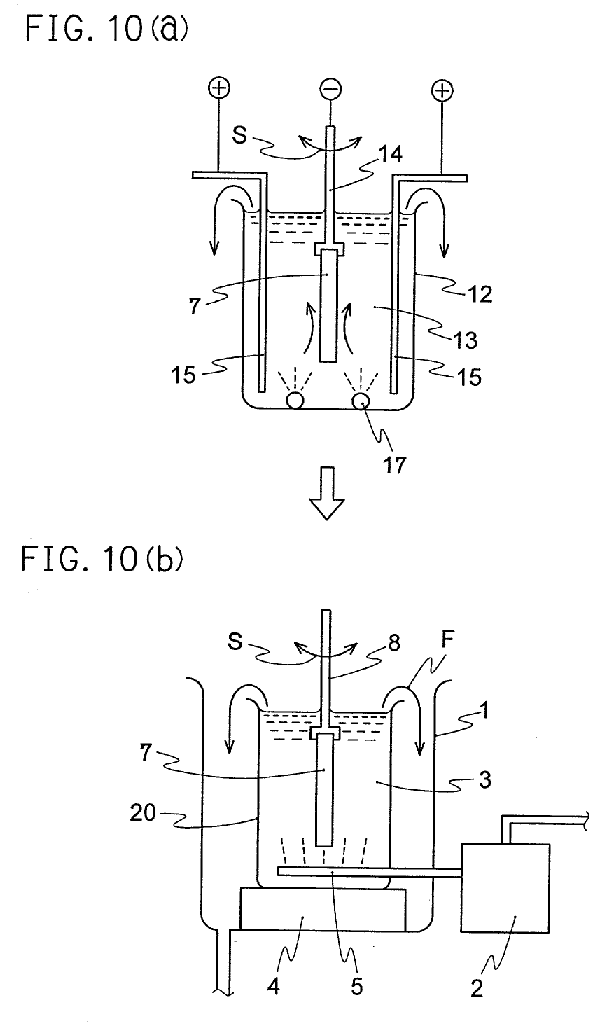

Hereinafter, the present embodiment is described with referring to FIG. 10. FIG. 10 shows washing apparatuses for Embodiment 8 of the present invention. FIG. 10(a) shows a pre-processing apparatus, while FIG. 10(b) shows an ultrasonic cleaning apparatus as same as that described in Embodiment 1. In the apparatus for the present embodiment shown in FIG. 10(a), the ultrasonic vibrator 16 of Embodiment 6 described in FIG. 9(a) is replaced by piping 17 for supplying the electrolytic degreasing agent 13 to the electrolysis bath 12.

In the present embodiment, an object 7 (i.e. a component of a sputtering equipment such as a target and shield) is subjected to electrolytic degreasing within the electrolysis bath 12 while overflowing the electrolytic degreasing agent 13 by supplying excess agent from the pipng 17 and swinging the object 7 by the device 14, and thereafter, subjected to the ultrasonic cleaning of the Embodiment 1 using de-aerated water within the washing bath 20.

To show advantages of the present embodiment, a sample object is prepared and cleaned. For the sample object, the same one used for the above embodiment is prepared. As for the washing conditions such as composition of the electrolytic agent and time for electrolytic degreasing, the same conditions as those of Embodiment 6 are applied. Needless to say, the electrolytic degreasing agent has been overflowing in the present embodiment instead of the application of ultrasonic to the agent in Embodiment 6.

As a result, a quantity of the dust collected by the present embodiment is approximately 1.2 times as large as that of Embodiment 1 wherein only the ultrasonic cleaning with de-aerated water (with swinging) is performed. Therefore, it is found that remained blast abrasives can be efficiently removed from the object by performing the pre-processing of electrolytic degreasing within the electrolysis bath overflowing the electrolytic degreasing agent.

Moreover, even when swinging of the object is not performed during the electrolytic degreasing, more remained blast abrasives stricken into the surface of the object can be removed compared with the cleaning method of Embodiment 1.

### Embodiment 9

In the case where the cleaning method of Embodiment 8, that is, overflowing of the electrolytic degreasing agent is combined with the cleaning method of Embodiment 6 or 7, the performance for removing the remained blast abrasives from the object is further enhanced.

Meanwhile, although electrolysis degreasing is carried out within the bath in the above Embodiments 6 to 9, any alternative process wherein gas is generated at the surface of the object to ease blast abrasives thereon by flow of the generated gas for easier removal of the abrasives is also applicable.

### Embodiment 10

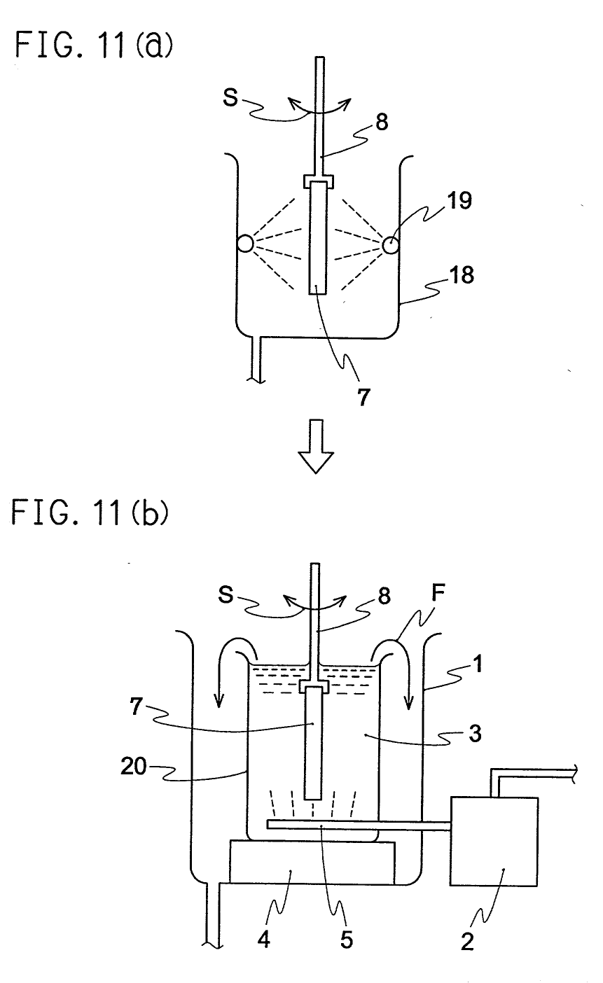

Hereinafter, the present embodiment is described with referring to FIG. 11. FIG. 11 shows washing apparatuses for Embodiment 10 of the present invention. FIG. 11(a) shows a pre-processing apparatus, while FIG. 11(b) shows an ultrasonic cleaning apparatus as same as that described in Embodiment 1. In the figure, numeral 18 denotes a shower bath in which an object 7 to be cleaned is placed, and numeral 19 denotes piping to shower etchant onto the object 7.

In the present embodiment, an object 7 (i.e. a component of a sputtering equipment such as a target and shield) is subjected to etching process within the bath 18 while showering etchant from the piping 18 and swinging the object 7 by the device 8, and thereafter, subjected to the ultrasonic cleaning of the Embodiment 1 using de-aerated water within the washing bath 20.

To show advantages of the present embodiment, a sample object is prepared and cleaned. For the sample object, Ti plate having a thickness of 3 mm and area of 50 mm² is used. The material of the Ti plate is the same as that of a Ti target used within a sputtering equipment, and a surface thereof is previously treated by blasting using blast abrasives of SiC #24. As for the etchant to be showered, 10% sulfuric acid is used. Both of the pre-process etching within the shower bath 18 and the ultrasonic cleaning within the bath 20 are performed for 10 minutes, respectively. Thereafter, the dust, i.e. foreign matters or blast abrasives, removed from the sample object is collected and measured by the method using a filter paper as described with Embodiment 1.

As a result, a quantity of the dust collected by the present embodiment is approximately 1.2 times as large as that of Embodiment 1 wherein only the ultrasonic cleaning with de-aerated water (with swinging) is performed. Therefore, it is found that more remained blast abrasives can be removed from the surface of the object by showering the etchant onto the object within the showering bath.

Moreover, even when showering of the etchant is performed without swinging the object within the showering bath, more remained blast abrasives stricken into the surface of the object can be removed compared with the cleaning method of Embodiment 1. By swinging the object in the shower of the etchant, there is expected an advantage that surface thereof can be uniformly etched.

While preferred embodiments of the present invention have been described, such descriptions are for illustrative purposes only, and it is to be understood that changes and variations may be made without departing from the sprit or scope of the present invention.

What is claimed is:

1. An ultrasonic cleaning method for cleaning a component of semiconductor manufacturing equipment,
wherein a surface of said component is previously treated by blast abrasives,
and wherein de-aerated cleaning water in which the component is immersed has concentration of dissolved oxigen of 10 ppm at the maximum, and ultrasonic power of the ultrasonic vibrator applying ultrasonic to the cleaning water is 50 W at the minimum.

2. The ultrasonic cleaning method of claim 1, wherein the semiconductor manufacturing equipment is a sputtering equipment.

3. The ultrasonic cleaning method of claim 1, wherein the de-aerated cleaning water has been overflowing during the ultrasonic cleaning.

4. The ultrasonic cleaning method of claim 1, wherein the component to be cleaned has been swung during the ultrasonic cleaning.

5. The ultrasonic cleaning method of claim 1, wherein frequency modulation is applied to the ultrasonic.

6. The ultrasonic cleaning method of claim 1, wherein an etching process is performed immersing the component into etchant before the ultrasonic cleaning.

7. The ultrasonic cleaning method of claim 6, wherein ultrasonic is applied to the etchant during the etching process.

8. The ultrasonic cleaning method of claim 6, wherein the etchant has been overflowing during the etching process.

9. The ultrasonic cleaning method of claim 6, wherein the component to be cleaned has been swung during the etching process.

10. The ultrasonic cleaning method of claim 7, wherein frequency modulation is applied to the ultrasonic during the etching process.

11. The ultrasonic cleaning method of claim 1, wherein a pre-process in which gas is generated at the surface of the component immersed into an agent is performed before the ultrasonic cleaning.

12. The ultrasonic cleaning method of claim 11, wherein ultrasonic is applied to the agent during the pre-process.

13. The ultrasonic cleaning method of claim 11, wherein the agent has been overflowing during the pre-process.

14. The ultrasonic cleaning method of claim 11, wherein the component to be cleaned has been swung during the pre-process.

15. The ultrasonic cleaning method of claim 12, wherein frequency modulation is applied to the ultrasonic during the pre-process.

16. The ultrasonic cleaning method of claim 1, wherein the component to be cleaned is subjected to a shower of etchant before the ultrasonic cleaning.

17. The ultrasonic cleaning method of claim 16, wherein the component to be cleaned has been swung in the shower of etchant.
